(19) United States
(12) Patent Application Publication
(10) Pub. No.: US 2010/0312654 A1
(43) Pub. Date: Dec. 9, 2010

(54) Method of distributing music online

(76) Inventor: Charles S. Parker, Steubenville, OH (US)

Correspondence Address: LITMAN LAW OFFICES, LTD., PATENT LAW BUILDING, 8955 CENTER STREET, MANASSAS, VA, 20110, US

(21) Appl. No.: 12/656,503

(22) Filed: Feb. 1, 2010

Related U.S. Application Data
(60) Provisional application No. 61/213,403, filed on Jun. 4, 2009.

(51) Int. Cl. G06Q 30/00; G06Q 50/00; G06Q 20/00; G06Q 10/00; G06F 15/16

(52) U.S. Cl. 705/14.73; 705/26; 709/219

(57) ABSTRACT

The method of distributing music online provides for the online sale of music and audio files, which are uploaded to an online music store directly by the artist rather than being provided by a record company. The online music store is established in a form accessible to potential purchasers via a computer network. Purchasers and the artists establish accounts on the music store website. An artist uploads at least one digital audio file to the online music store. The at least one digital audio file is stored on a server accessible by or through the online store. The artist pays an artist fee to the online music store for offering the at least one digital audio file for sale on the website. An established portion of the artist fee to be contributed to a selected charity is calculated, and this portion of the artist fee is distributed to the charity.

### CROSS-REFERENCE TO RELATED APPLICATION

This application claims the benefit of U.S. Provisional Patent Application Ser. No. 61/213,403, filed Jun. 4, 2009.

### BACKGROUND OF THE INVENTION

1. Field of the Invention

The present invention relates to online sale and distribution of digital files, and particularly to a method of distributing music online that provides for direct distribution by the artist with a portion of the proceeds being contributed to charity.

2. Description of the Related Art

Presently, record companies take a great deal of risk when they sign an artist or artists to recording contracts. Talent scouts for record companies find artists with potential, based on highly subjective standards, and record company executives apply further highly subjective standards in the decision of whether to offer a contract. Most artists who are signed by record companies have only played their music live, or have produced amateur recordings of their music for free distribution. Thus, record companies do not know in advance how well a professional recording of an artist will sell, since a contract must first be issued to the artist before a recording can be made, and before sales data associated with that recording exist.

A great deal of time, effort, resources and funds are spent in the recording and promotion of music of new artists. Unfortunately, no data exists for a new artist as to how well his or her music will actually sell. Thus, a method of distributing music online solving the aforementioned problems is desired.

### SUMMARY OF THE INVENTION

The method of distributing music online provides for the online sale of music and audio files that are uploaded to an online music store directly by the artist, rather than being provided by a record company. The online music store is first established in a form accessible by potential purchasers via a computer network, such as the Internet. The online music store may be presented to potential purchasers and to artists as a website on the World Wide Web, although FTP sites, Telnet, or other network modes might be used.

Potential purchasers and the artists of the music and audio files for sale establish accounts on the music store website. An artist uploads at least one digital audio file to the online music store, where the at least one digital audio file (which may be in any format commonly used for storage and subsequent transfer of audio over a computer network) is stored either directly on the online music store's web server, or on a back-end file server or database server accessible by the web server through a local area network (LAN), or directly though the Internet, or other suitable network architecture. The artist pays an artist fee to the online music store for offering the at least one digital audio file for sale on the website. Preferably, the artist fee is renewed according to a set time period, such as monthly, for example.

An established portion of the artist fee to be contributed to a selected charity is calculated by the web server, and this portion of the artist fee is distributed to the selected charity by the online store. Copies of the at least one digital audio file are offered for sale online, and a royalty fee to be paid to the artist upon sale of at least one copy of the at least one digital audio file is established. Upon purchase of one or more copies of the at least one digital audio file, the purchaser pays the online store for the one or more copies, preferably electronically, and the copy or copies of the digital audio file are transmitted to the purchaser over the network or, alternatively, by CD, DVD, or other medium shipped to the purchaser by the online store, by the artist, or by a third party distributor.

The artist is paid a royalty fee per sale of the at least one digital file. The remainder of the sale price is paid to the online store, as well as one or more charities. Sales data associated with the sale of the at least one copy is recorded by the online store, and the sales data may be transmitted to one or more record companies. In exchange for the sales data, the record companies enter into a licensing agreement with the online music store. For example, in exchange for use on the website of a record company's logo or trademark, the record company is provided with sales data, including numbers of sales for each artist, demographic data on purchasers, and the like.

These and other features of the present invention will become readily apparent upon further review of the following specification and drawings.

### BRIEF DESCRIPTION OF THE DRAWINGS

FIG. 1 is a diagrammatic view of a system for implementing a method of distributing music online according to the present invention.

FIG. 2 is a block diagram illustrating an online music store of the method of distributing music online according to the present invention.

FIG. 3 is a flow diagram illustrating the steps of the method of distributing music online according to the present invention.

Similar reference characters denote corresponding features consistently throughout the attached drawings.

### DETAILED DESCRIPTION OF THE PREFERRED EMBODIMENTS

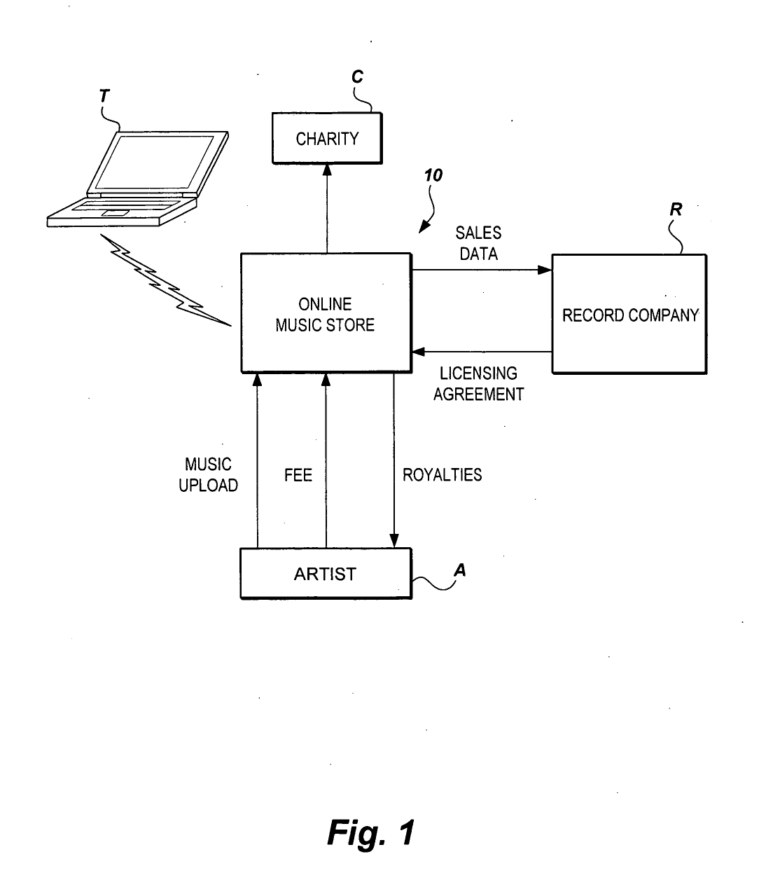

FIG. 1 illustrates an overview of the present method of distributing music online. The method provides for the online sale of music and audio files, which are uploaded to an online music store 10 directly by the artist A, rather than being provided by a record company R. The online music store 10 is first established so that the store is reachable by potential purchasers using exemplary terminals T via a computer network, such as the Internet. As used herein, the term “terminal” may refer to a terminal in a Telnet or FTP system, but also includes a client computer operating in a client/server architecture. The online music store 10 may be presented to potential purchasers and to artists as a website on the World Wide Web, for example. It should be understood that one or more user terminals T may communicate with the online music store 10 through any suitable type of computer network, such as a local area network or a wide area network (such as the Internet).

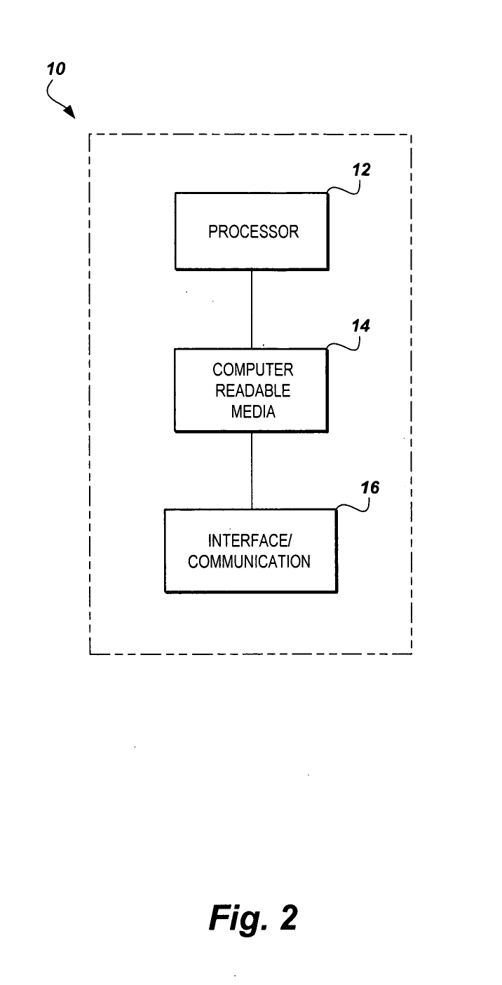

The online music store 10 is preferably provided as a website on the World Wide Web, with the associated software, hardware and communication protocols being associated with at least one server. As shown in FIG. 2, the server for the online music store 10 includes at least a processor 12, which may be any suitable type of computer processor or programmable logic controller, which is in communication with computer readable media 14. Computer readable media 14 may be any suitable type of computer readable media, including, for example, magnetic and solid state computer readable media. An interface 16 is in communication with processor 12 and computer readable media 14, enabling communication with local users and telecommunication with terminals T and the remote record company R. Interface 16 may be any suitable type of network interface, and may also include a local interface, such as a keyboard, mouse and monitor, for example, for local programming and information retrieval.

The online store 10 may particularly have a web server that presents a front-end including web pages presented to artists, purchasers, and other users, and a back-end that includes a file server, a database server, scripts, and applications that are stored and executed directly on the web server, or that are accessible by the web server through a local area network (LAN) or directly through the Internet.

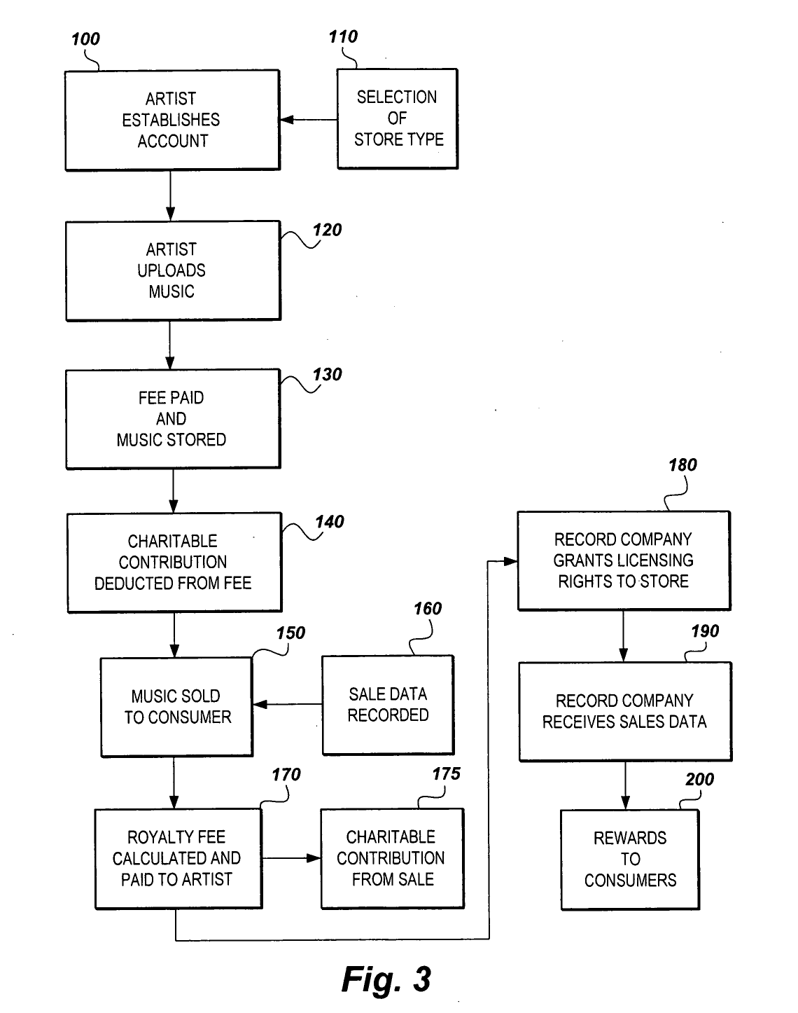

Potential purchasers and the artists of the music and audio files for sale establish accounts on the music store website. At step 100, in FIG. 3, an artist with music for sale establishes an account with the online music store 10. At this time, the artist may select the type of store desired (step 110). As will be described below, the artist pays a fee for use of the online music store 10. Three different types of stores, for example, may be provided to the artist: A first sales level or store with a relatively low fee to be paid to the online music store, but with a corresponding low royalty fee paid back to the artist; a second sales level or store with a relatively high fee to be paid to the online music store, but with a corresponding relatively high royalty fee paid back to the artist; and a third median level or store, with a median fee being paid corresponding to a median royalty fee.

As will be described in detail below, sales data is recorded and may be transmitted to one or more record companies. In order to provide bias-free sales, marketing and demographic data, preferably potential purchasers (via terminals T) are not provided with information regarding the artist's selected level or royalty fee. Further, all music and audio files are preferably offered to potential purchasers at the same price. Additionally, the popularity (i.e., the number of sales) of one or more audio files may be provided to the record companies, but is preferably kept hidden from the purchasers. Further, in order to remove potential bias in the sales data, each artist is provided with an equivalent promotional space or display on the online music store website. For example, displayed names, logos, information or audio clips will be limited to a set display size, with all display sizes being preferably equal for all artists.

The artist uploads at least one digital audio file to the online music store at step 120, where the at least one digital audio file is stored on a file server or database server accessible by the online music store 10. Alternatively, the artist may maintain the digital audio file on his own file server or a third party file server connected to the network and upload a hyperlink to the digital audio file storage location. The artist pays the artist fee to the online music store for offering the at least one digital audio file (or hyperlink to the digital audio file) for sale on the website at step 130, with the fee being dependent upon the store type selected at step 110. Preferably, the artist fee is paid on a renewal-basis, with the renewal occurring according to a set time period, such as monthly, for example.

An established portion of the artist fee to be contributed to a selected charity C is calculated by the online store web server at step 140, and this portion of the artist fee is distributed to the selected charity. The charitable contribution may be distributed to the selected charity via any suitable process, such as electronic transfer, the printing and mailing of a check, or the like. The portion of the artist fee to be distributed to charity C may be any desired percentage.

Copies of the at least one digital audio file are offered for sale online through the online store web server, and a royalty fee to be paid to the artist upon sale of at least one copy of the at least one digital audio file is established. Upon sale of one or more copies of the at least one digital audio file (step 150), the purchaser pays for the one or more copies, preferably through electronic transfer of funds, and the copy or copies of the digital audio file are transmitted to the purchaser either electronically through the network on demand, or on physical media shipped to the purchaser, either by the online store, by the artist, or by a third party distributor. Any suitable method of payment by the purchaser, electronic or otherwise, may be utilized.

At least a portion of the royalty fee is paid to the artist by the online store website at step 170. The portion of the royalty fee may be transferred electronically to the artist, or may be delivered via any suitable method, such as printing and mailing a check, for example. Optionally, the remainder of the royalty fee may also be distributed to the selected charity (step 175) by the online store. The established sale price for the audio file is divided into a portion retained by the online music store as profit, into the selected royalty payment for the artist, into a selected charitable contribution, and possibly into further charitable donations, as desired by the artist, with these further donations being taken from the artist's royalty payment. Additionally, the artist may choose to apply the royalty payment, or a portion thereof, toward future fees for storage and display on the website. Such fees are preferably monthly fees, rather than a one-time fee.

Sales data associated with the sale of the at least one copy is recorded by the online store 10 at step 160, and the sales data may be transmitted to one or more record companies at step 190. In exchange for the sales data, the record companies enter into a licensing agreement with the online music store (step 180). For example, in exchange for usage on the website of a record company's logo or trademark, the record company is provided with sales data, including numbers of sales for each artist, demographic data on purchasers, and the like.

Based upon the sales data, a record company may choose to award an artist with a recording contract. Optionally, at step 200, the artist may choose to reward purchasers of his or her music via a public message, transmitted through the online music store 10, and by providing past purchasers with free downloads of music files from the online music store 10. As noted above, at step 110, the artist selects the type of store desired. The artist pays a fee for use of the online music store 10. As further noted above, three different types of stores, for example, may be provided to the artist: A first sales level or store with a relatively low fee to be paid to the online music store, but with a corresponding low royalty fee paid back to the artist; a second sales level or store with a relatively high fee to be paid to the online music store, but with a corresponding relatively high royalty fee paid back to the artist; and a third median level or store, with a median fee being paid corresponding to a median royalty fee. In addition to a set fee for the artist to sell a downloadable song in the chosen store, this fee may be based on a certain time period; i.e., similar to “renting” space in the store for a set time period, such as a month, for example.

This set time period prevents the online store from becoming a repository of unwanted music, as the artists will be motivated to remove non-selling items from the store. Additionally, the artists can preferably move media from one store to another. As an example, if a song does not sell well, and is initially offered in a “high rent” store (i.e., a store with higher royalties), the artist may choose to move the song to a “low rent” store, in order to save on fees.

Preferably, the above server-dependent steps are performed via software instructions stored in the computer readable media 14 and implemented by processor 12. It should be understood that the calculations and other method-related instructions may be performed by any suitable computer system, such as that diagrammatically shown in FIG. 2. Data is entered into system 10 via any suitable type of user interface 16, and may be stored in memory 14, which may be any suitable type of computer readable and programmable memory. Calculations and instructions are performed by processor 12, which may be any suitable type of computer processor and may be displayed to the user on a separate display (or other type of user output interface) which may be any suitable type of computer display or the like.

Processor 12 may be associated with, or incorporated into, any suitable type of computing device, for example, a personal computer or a programmable logic controller. The display, the processor 12, the memory and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 14, or in place of memory 14, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

I claim:

1. A computerized method of distributing music online through a computer network, comprising the steps of:
establishing an online music store;
receiving an upload of at least one digital audio file to the online music store directly from an artist;
storing the at least one digital audio file on a server accessible by the online music store;
paying an artist fee to the online music store in exchange for offering the at least one digital audio file for sale in the online store;
calculating a portion of the artist fee to be contributed to a selected charity;
distributing the portion of the artist fee to the selected charity;
offering copies of the at least one digital audio file for sale in the online store over the computer network;
calculating a royalty fee to be paid to the artist upon sale of at least one copy of the at least one digital audio file;
receiving an order for purchase of a copy of the digital audio file by the online store and receiving payment of a purchase price by a purchaser to the online store through the computer network;
transmitting the copy of the digital audio file to the purchaser; and
distributing at least a portion of the royalty fee from the purchase price to the artist.

2. The computerized method of distributing music online through a computer network as recited in claim 1, further comprising the steps of:
recording sales data associated with the sale of the at least one copy; and
transmitting the sales data to a record company.

3. The computerized method of distributing music online through a computer network as recited in claim 2, further comprising the step of displaying advertising associated with the record company in the online store.

4. The computerized method of distributing music online through a computer network as recited in claim 1, further comprising the step of distributing a portion of the royalty fee to the selected charity.

5. The computerized method of distributing music online through a computer network as recited in claim 1, wherein said step of paying the artist fee to the online music store in exchange for offering the at least one digital audio file for sale in the online store comprises the further steps of defining a set time period and making an artist fee payment each said set time period.

6. A system for distributing music online through a computer network, comprising:
a processor;
computer readable memory coupled to the processor;
a network interface coupled to the processor;
software stored in the computer readable memory and executable by the processor, the software having:
means for establishing an online music store;
means for receiving an upload of at least one digital audio file to the online music store directly from an artist;
means for storing the at least one digital audio file on a server accessible by the online music store;
means for paying an artist fee to the online music store in exchange for offering the at least one digital audio file for sale in the online store;
means for calculating a portion of the artist fee to be contributed to a selected charity;
means for distributing the portion of the artist fee to the selected charity;
means for offering copies of the at least one digital audio file for sale in the online store over the computer network;
means for calculating a royalty fee to be paid to the artist upon sale of at least one copy of the at least one digital audio file;
means for receiving an order for purchase of a copy of the digital audio file by the online store and receiving payment of a purchase price by a purchaser to the online store through the computer network;
means for transmitting the copy of the digital audio file to the purchaser; and
means for distributing at least a portion of the royalty fee from the purchase price to the artist.

7. The system for distributing music online as recited in claim 6, wherein the software further includes means for recording sales data associated with the sale of the at least one copy and means for transmitting the sales data to a record company.

8. The system for distributing music online as recited in claim 7, wherein the software further includes means for displaying advertising associated with the record company in the online store.

9. The system for distributing music online as recited in claim 8, wherein the software further includes means for distributing a portion of the royalty fee to the selected charity.

10. A computer software product that includes a medium readable by a processor, the medium having stored thereon a set of instructions for distributing music online through a computer network, the instructions comprising:
(a) a first sequence of instructions which, when executed by the processor, causes the processor to establish an online music store;
(b) a second sequence of instructions which, when executed by the processor, causes the processor to receive an upload of at least one digital audio file to the online music store directly from an artist;
(c) a third sequence of instructions which, when executed by the processor, causes the processor to store the at least one digital audio file on a server accessible by the online music store;
(d) a fourth sequence of instructions which, when executed by the processor, causes the processor to receive an artist fee paid to the online music store in exchange for offering the at least one digital audio file for sale in the online store;
(e) a fifth sequence of instructions which, when executed by the processor, causes the processor to calculate a portion of the artist fee to be contributed to a selected charity;
(f) a sixth sequence of instructions which, when executed by the processor, causes the processor to distribute the portion of the artist fee to the selected charity;
(g) a seventh sequence of instructions which, when executed by the processor, causes the processor to offer copies of the at least one digital audio file for sale in the online store over the computer network;
(h) an eighth sequence of instructions which, when executed by the processor, causes the processor to calculate a royalty fee to be paid to the artist upon sale of at least one copy of the at least one digital audio file;
(i) a ninth sequence of instructions which, when executed by the processor, causes the processor to receive an order for purchase of a copy of the digital audio file by the online store and receiving payment of a purchase price by a purchaser to the online store through the computer network;
(j) a tenth sequence of instructions which, when executed by the processor, causes the processor to transmit the copy of the digital audio file to the purchaser; and
(k) an eleventh sequence of instructions which, when executed by the processor, causes the processor to distribute at least a portion of the royalty fee from the purchase price to the artist.

11. The computer software product as recited in claim 10, wherein the instructions further comprise a twelfth sequence of instructions which, when executed by the processor, causes the processor to record sales data associated with the sale of the at least one copy, and a thirteenth sequence of instructions which, when executed by the processor, causes the processor to transmit the sales data to a record company.

12. The computer software product as recited in claim 11, wherein the instructions further comprise a fourteenth sequence of instructions which, when executed by the processor, causes the processor to display advertising associated with the record company in the online store.

13. The computer software product as recited in claim 12, wherein the instructions further comprise a fifteenth sequence of instructions which, when executed by the processor, causes the processor to distributing a portion of the royalty fee to the selected charity.
